(19) United States
(12) Patent Application Publication
(10) Pub. No.: US 2019/0037647 A1
(43) Pub. Date: Jan. 31, 2019

(54) HEATER AND GLOW PLUG INCLUDING THE SAME

(71) Applicant: KYOCERA Corporation, Kyoto-shi, Kyoto (JP)

(72) Inventor: Norimitsu HIURA, Kirishima-shi (JP)

(73) Assignee: KYOCERA Corporation, Kyoto-shi, Kyoto (JP)

(21) Appl. No.: 16/071,979

(22) PCT Filed: Feb. 2, 2017
(86) PCT No.: PCT/JP2017/003743

§ 371 Date: Jul. 23, 2018

(30) Foreign Application Priority Data
Feb. 4, 2016 (JP) 2016-020023

(51) Int. Cl. H05B 3/18; H05B 3/48; F23Q 7/00; H05B 3/44; F23Q 7/22; H05B 3/12; H05B 3/28

(52) U.S. Cl. CPC H05B 3/18; H05B 3/48; F23Q 7/001; H05B 2203/027; F23Q 7/22; H05B 3/12; H05B 3/283; H05B 3/44

(57) ABSTRACT

A heater includes: a ceramic body having a rod-like shape, including an end face and an outer periphery face; and a heat generating resistor embedded in the ceramic body, a surface roughness of the end face of the ceramic body being larger than a surface roughness of the outer periphery face of the ceramic body.

### TECHNICAL FIELD

The present disclosure relates to a heater which is used as, for example, a heater for ignition or flame detection for use in a combustion-type vehicle-mounted heating unit, a heater for ignition for use in various combustors such as an oil fan heater, a heater for use in a glow plug of a diesel engine, a heater for use in various sensors such as an oxygen sensor, or a heater for heating of measuring equipment, etc., and also relates to a glow plug including the same.

### BACKGROUND ART

As an example of such a heater, for example, there is known a heater described in Japanese Unexamined Patent Publication JP-A 2015-18625 (hereafter referred to as “Patent Literature 1”). The heater described in Patent Literature 1 comprises a rod-like ceramic body and a heat generating resistor disposed within the ceramic body. The heat generating resistor comprises two linear portions and a folded-back portion which connects the two linear portions. In recent years, an improvement in long-term reliability has been demanded in heaters.

### SUMMARY OF INVENTION

A heater according to the present disclosure comprises: a ceramic body having a rod-like shape, comprising an end face and an outer periphery face; and a heat generating resistor embedded in the ceramic body, a surface roughness of the end face of the ceramic body being larger than a surface roughness of the outer periphery face of the ceramic body.

A glow plug according to the present disclosure comprises: a heater; and a metal-made holding member which holds the heater.

### BRIEF DESCRIPTION OF DRAWINGS

FIG. 1 is a sectional view showing an embodiment of a heater;

FIG. 2 is a sectional view showing another embodiment of a heater;

FIG. 3 is a sectional view showing another embodiment of a heater; and

FIG. 4 is a sectional view showing an embodiment of a glow plug.

### DESCRIPTION OF EMBODIMENTS

As shown in FIG. 1, a heater 1 comprises: a ceramic body 2; a heat generating resistor 3 embedded in the ceramic body 2; and a lead 4 connected to the heat generating resistor 3 and drawn out to a surface of the ceramic body 2.

For example, the ceramic body 2 of the heater 1 has the form of a rod having a longitudinal direction. Examples of the rod-like form include a circular column form and an elliptic column form. The ceramic body 2 has the heat generating resistor 3 and the lead 4 embedded therein. The ceramic body 2 is formed of ceramics. Thus, there is provided the heater 1 designed for high reliability even during rapid temperature rise. As the ceramics, it is possible to use electrically insulating ceramics such as oxide ceramics, nitride ceramics, or carbide ceramics. It is advisable that the ceramic body 2 is formed of silicon nitride ceramics, in particular. This is because silicon nitride ceramics contains, as a major constituent, silicon nitride which is superior in points of strength, toughness, insulation capability, and resistance to heat. For example, the ceramic body 2 formed of silicon nitride ceramics may be obtained by mixing silicon nitride used as a major constituent with sintering aids, namely a rare-earth element oxide such as Y₂O₃, Yb₂O₃, or Er₂O₃ in an amount of 3 to 12% by mass, Al₂O₃ in an amount of 0.5 to 3% by mass, and SiO₂ in an amount determined so that the range of the amount of SiO₂ contained in a resultant sintered product will be from 1.5 to 5% by mass, shaping the mixture into a body of predetermined configuration, and performing hot-press firing on the body at 1650° C. to 1780° C. The ceramic body 2 has a length of 20 mm to 50 mm, for example, and has a diameter of 3 mm to 5 mm, for example.

In the case of using a material comprising silicon nitride ceramics for the ceramic body 2, for example, MoSiO₂ or WSi₂ may be admixed in dispersed condition in the material. This makes it possible to render silicon nitride ceramics serving as a matrix analogous in thermal expansion coefficient to the heat generating resistor 3, and thereby enhance the durability of the heater 1.

The heat generating resistor 3 is disposed within the ceramic body 2. The heat generating resistor 3 is located on the front end side (one end side) of the ceramic body 2. The heat generating resistor 3 is a member configured to generate heat when an electric current flows therethrough. The heat generating resistor 3 is composed of: a first linear portion 31a and a second linear portion 31b each extending in a longitudinal direction of the ceramic body 2; and a folded-back portion 32 which connects the first linear portion 31a and the second linear portion 31b. As the material of construction of the heat generating resistor 3, it is possible to use, for example, materials predominantly composed of a carbide, a nitride, or a silicide of W, Mo, or Ti. Where the ceramic body 2 is formed of silicon nitride ceramics, among such materials, tungsten carbide (WC), in particular, is excellent for use as the material of construction of the heat generating resistor 3, because it differs little from the ceramic body 2 in thermal expansion coefficient, and has high resistance to heat.

Moreover, where the ceramic body 2 is formed of silicon nitride ceramics, the heat generating resistor 3 may be predominantly composed of WC, which is an inorganic conductive element, with silicon nitride contained in an amount of 20% by mass or above. For example, in the ceramic body 2 formed of silicon nitride ceramics, due to the conductor component constituting the heat generating resistor 3 having a relatively large thermal expansion coefficient compared to silicon nitride, tensile stress is applied under normal conditions. In this regard, the addition of silicon nitride to the heat generating resistor 3 allows the heat generating resistor 3 to be analogous in thermal expansion coefficient to the ceramic body 2, and thus achieves relaxation of the stress caused by the difference in thermal expansion coefficient during a rise or fall in the temperature of the heater 1.

Moreover, where the heat generating resistor 3 has a silicon nitride content of 40% by mass or less, variations in the resistance of the heat generating resistor 3 can be reduced. Thus, the silicon nitride content in the heat generating resistor 3 may fall within a range of 20 to 40% by mass. Alternatively, the silicon nitride content in the heat generating resistor 3 may fall within a range of 25 to 35% by mass. Moreover, instead of silicon nitride, as a similar additive component to be included in the heat generating resistor 3, boron nitride may be added in an amount of 4 to 12% by mass. The heat generating resistor 3 may be set for an entire length of 3 to 15 mm, and set for a cross-sectional area of 0.15 to 0.8 mm².

The lead 4 is a member for electrically connecting the heat generating resistor 3 and an external power supply. The lead 4 is connected to the heat generating resistor 3, and is drawn out to the surface of the ceramic body 2. More specifically, the lead 4 is joined to each of the opposite ends of the heat generating resistor 3, and, one lead 4 is connected, at one end thereof, to one end of the heat generating resistor 3, and is drawn, at the other end thereof, to a part of a side face of the ceramic body 2 located on the rear end side of the ceramic body 2, and, on the other hand, the other lead 4 is connected, at one end thereof, to the other end of the heat generating resistor 3, and is drawn, at the other end thereof, to the rear end of the ceramic body 2.

For example, the lead 4 is formed of a material similar to that used for the heat generating resistor 3. The lead 4 is made larger than the heat generating resistor 3 in cross-sectional area, or made smaller than the heat generating resistor 3 in the content of ceramic body 2-constituting material, to lower its resistance per unit length. Moreover, the lead 4 may be predominantly composed of WC, which is an inorganic conductive element, with silicon nitride contained in an amount of 15% by mass or above. As the content of silicon nitride is increased, the thermal expansion coefficient of the lead 4 is brought to a level analogous to the thermal expansion coefficient of silicon nitride constituting the ceramic body 2 correspondingly. Moreover, where the content of silicon nitride is less than or equal to 40% by mass, variations in the resistance of the lead 4 can be reduced. Thus, the silicon nitride content in the lead 4 may fall within a range of 15 to 40% by mass. Alternatively, the silicon nitride content in the lead 4 may fall within a range of 20 to 35% by mass.

The heater 1 comprises: the rod-like ceramic body 2 having an end face 21 (front end face) and an outer periphery face 22; and the heat generating resistor 3 embedded in the ceramic body 2, wherein a surface roughness of the end face 21 of the ceramic body 2 is larger than a surface roughness of the outer periphery face 22 of the ceramic body 2.

Considering transfer of heat from the ceramic body 2 to a contacting object, the larger a surface roughness of the ceramic body 2 is, the thinner a boundary film between the ceramic body 2 and the contacting object is. That is, as in the heater 1, where the surface roughness of the end face 21 of the ceramic body 2 is larger than the surface roughness of the outer periphery face 22 of the ceramic body 2, the boundary film at the end face 21 is thinner than the boundary film at the outer periphery face 22. Thus, when the contacting object is brought into contact with the ceramic body 2, the end face 21 is subjected to greater thermal shock, because the end face 21 is more susceptible to heat transfer than the outer periphery face 22. Generally, in the rod-like ceramic body 2, the strength tends to become low with respect to a force exerted on the outer periphery face 22, and the strength tends to become high with respect to a force exerted on the end face 21. Thus, by generating thermal shock on the end face 21 which has a relatively high strength compared to the outer periphery face 22, it is possible to reduce the likelihood of occurrence of cracking in the ceramic body 2, and thereby improve the long-term reliability of the heater 1.

As to the end face 21 and the outer periphery face 22 described herein, for example, in the heater 2 shown in FIG. 1, an axially elongated face of the rod-like ceramic body 2 having a uniform thickness is defined as the outer periphery face 22, and, a face of the ceramic body 2 located on the front end side beyond the outer periphery face 22 is defined as the end face 21. In other words, the end face 21 refers to the entire surface of a part of the ceramic body 2 which extends from the center of the front end to the outer periphery face 22.

For example, determination of surface roughness can be carried out by the following method. More specifically, the surface of the ceramic body 2 is axially measured in respect of surface roughness. The measurement of surface roughness may be effected with use of a surface-texture measuring instrument “SURFCOM” manufactured by TOKYO SEIMITSU CO., LTD. Moreover, the surface roughness may be determined in terms of maximum height of profile Rz defined in JIS B 0601 (2001) 4.1.3. As employed herein the maximum height of profile Rz refers to a value obtained by measuring a height difference between the highest peak and the lowest valley of a roughness curve excluding surface undulations. That is, the larger the value Rz, the greater the degree of surface roughness. For example, the maximum height of profile Rz of the end face 21 may be set at 2 to 3 μm, and the maximum height of profile Rz of the outer periphery face 22 may be set at 1.5 to 2 μm. Adjustment of surface roughness may be made by grinding the surface of the ceramic body 2.

Moreover, a surface roughness at the center region of the end face 21 may be larger than a surface roughness at the outer periphery region of the end face 21. In this case, a focus of thermal shock applied to the end face 21 can fall on the center region of the end face 21, and thus the thermal shock can be readily scattered throughout the interior of the ceramic body 2 with reduced unevenness. As employed herein the outer periphery region and the center region refer to the outer region and the central region, respectively, when the end face 21 of the ceramic body 1 is viewed from an extension line in an axial direction of the ceramic body 1. Expressed differently, the outer periphery region of the end face 21 is located between the center region of the end face 21 and the outer periphery face 22. For example, demarcation between the center region and the outer periphery region may be established by the following method. That is, on the basis of a phantom line drawn at a position spaced equally from each of “the center of the end face 21” and “the boundary between the outer periphery face 22 and the end face 21”, a region of the end face 21 surrounded by the phantom line is regarded as “the center region”, and, other region than the center region is regarded as “the outer periphery region”.

Moreover, the outer periphery region of the end face 21 may merge smoothly with the outer periphery face 22. This allows, when thermal shock is generated, the boundary between the end face 21 and the outer periphery face 22 to be less prone to concentration of thermal shock-caused force.

Moreover, the end face 21 may be given a convex form (the form of a convexly curved surface). In this case, the end face 21, being free of a corner, a shoulder or the like, is less prone to local stress concentration. Examples of the convex form include a domical form. As employed herein the domical form just means a dome-shaped outer appearance. That is, there is no need for the end face 21 to form a cavity therein like a real dome.

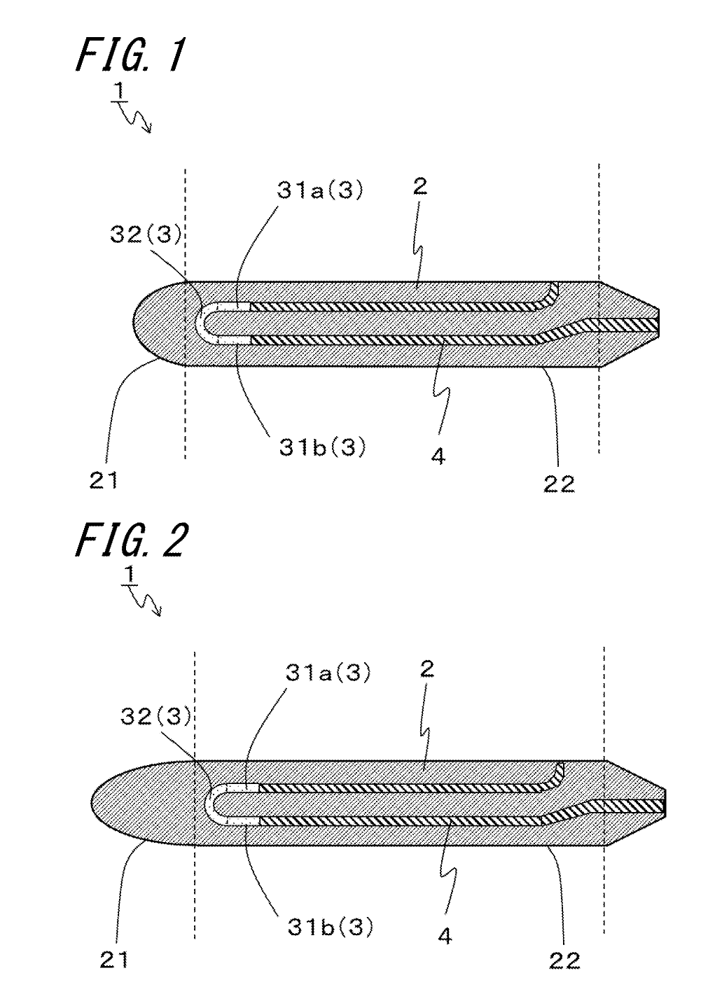

Moreover, as shown in FIG. 2, when the ceramic body 2 is viewed in a section extending in an axial direction of the ceramic body 2, a radius of curvature at the outer periphery region of the end face 21 may be larger than a radius of curvature at the center region of the end face 21. This makes it possible to locate the center region of the end face 21 which is prone to thermal stress concentration away from the outer periphery face 22, while imparting smoothness to the boundary between the end face 21 and the outer periphery face 22. Consequently, concentration of thermal shock-caused force on the outer periphery face 22 can be reduced.

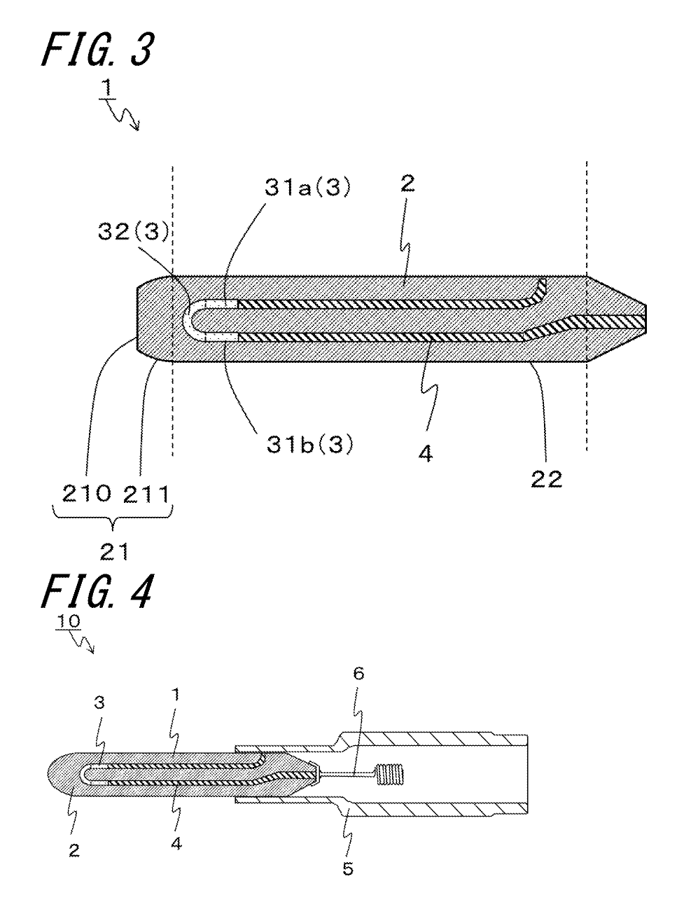

Moreover, as shown in FIG. 3, the end face 21 may comprise an orthogonal face 210 orthogonal to the axial direction of the ceramic body 2, and an inclined face 211 which connects the orthogonal face 210 and the outer periphery face 22. This makes it possible to cause the ceramic body 2 to have a gentle temperature distribution from the front end side toward the rear end side while concentrating the thermal shock on the orthogonal face 210. Consequently, local concentration of thermal stress can be reduced.

As shown in FIG. 4, a glow plug 10 comprises the heater 1 described above and a tubular metallic tube 5 mounted so as to cover the rear end side (the other end side) of the heater 1. Moreover, the glow plug 10 comprises an electrode fitting 6 located within the metallic tube 5 and attached to the rear end of the heater 1. According to the glow plug 10, since the heater 10 described above is used, rapid temperature rise is possible.

The metallic tube 5 is a member for holding the ceramic body 2. The metallic tube 5 is a tubular member which is mounted so as to surround the rear end side of the ceramic body 2. That is, the rod-like ceramic body 2 is inserted into the tubular metallic tube 5. The metallic tube 5 is disposed on a part of the side face of the ceramic body 2 located on the rear end side and is electrically connected to the lead 4-exposed part. For example, the metallic tube 5 is formed of stainless steel or an iron (Fe)-nickel (Ni)-cobalt (Co) alloy.

The metallic tube 5 and the ceramic body 2 are joined to each other via a brazing material. The brazing material is applied between the metallic tube 5 and the ceramic body 2 so as to surround the rear end side of the ceramic body 2. The placement of the brazing material permits electrical connection between the metallic tube 5 and the lead 4.

As the brazing material, it is possible to use silver (Ag)-copper (Cu) solder containing a glass component in an amount of 5 to 20% by mass, Ag solder, Cu solder, etc. The glass component exhibits good wettability to ceramics constituting the ceramic body 2 and possesses a high coefficient of friction, and thus allows an improvement in the bonding strength between the brazing material and the ceramic body 2 or the bonding strength between the brazing material and the metallic tube 5.

The electrode fitting 6 is located within the metallic tube 5, and is attached to the rear end of the ceramic body 2 so as to be electrically connected to the lead 4. While the electrode fitting 6 may be implemented in various forms, in the case shown in FIG. 4, the electrode fitting 6 is composed of a cap portion attached to the rear end of the ceramic body 2 so as to cover the rear end inclusive of the lead 4, a coiled portion electrically connected to an external connection electrode, and a linear portion via which the cap portion and the coiled portion are connected to each other. The electrode fitting 6 is held apart from an inner periphery face of the metallic tube 5 to prevent short-circuiting between the electrode fitting 6 and the metallic tube 5.

The electrode fitting 6 is a metallic wire having the coiled portion intended for relaxation of a stress resulting from connection with an external power supply. The electrode fitting 6 is electrically connected to the lead 4, and is also electrically connected to the external power supply. Upon application of voltage between the metallic tube 5 and the electrode fitting 6 by the external power supply, electric current can be passed through the heat generating resistor 3 via the metallic tube 5 and the electrode fitting 6. For example, the electrode fitting 6 is formed of nickel or stainless steel.

### REFERENCE SIGNS LIST

1: Heater
2: Ceramic body
21: End face
22: Outer periphery face
3: Heat generating resistor
4: Lead
5: Metallic tube
6: Electrode fitting
10: Glow plug

1. A heater, comprising:
a ceramic body having a rod-like shape, comprising an end face and an outer periphery face; and
a heat generating resistor embedded in the ceramic body,
a surface roughness of the end face of the ceramic body being larger than a surface roughness of the outer periphery face of the ceramic body.

2. The heater according to claim 1, wherein a surface roughness at a center region of the end face is larger than a surface roughness at an outer periphery region of the end face.

3. The heater according to claim 1, wherein an outer periphery region of the end face merges smoothly with the outer periphery face.

4. The heater according to claim 1, wherein the end face has a convex form.

5. The heater according to claim 4, wherein, when the ceramic body is viewed in a section extending in an axial direction of the ceramic body, a radius of curvature at an outer periphery region of the end face is larger than a radius of curvature at a center region of the end face.

6. The heater according to claim 1, wherein the end face comprises an orthogonal face orthogonal to an axial direction of the ceramic body, and an inclined face which connects the orthogonal face and the outer periphery face.

7. A glow plug, comprising:
a heater according to claim 1; and
a metal-made holding member which holds the heater.
